(19) United States
(12) Patent Application Publication
(10) Pub. No.: US 2024/0340133 A1
(43) Pub. Date: Oct. 10, 2024

(54) METHOD AND APPARATUS FOR DEALING WITH SYNCHRONOUS BEACON TRANSMISSION IN MULTI-ACCESS-POINT SYSTEM

(71) Applicant: MEDIATEK INC., Hsin-Chu (TW)

(72) Inventors: Chien-Fang Hsu, Hsinchu City (TW); Hung-Tao Hsieh, Hsinchu City (TW)

(73) Assignee: MEDIATEK INC., Hsin-Chu (TW)

(21) Appl. No.: 18/629,952

(22) Filed: Apr. 9, 2024

Related U.S. Application Data
(60) Provisional application No. 63/495,134, filed on Apr. 10, 2023.

(51) Int. Cl. H04L 5/00; H04W 72/044

(52) U.S. Cl. CPC H04L 5/0048; H04L 5/0035; H04W 72/044

(57) ABSTRACT

A beacon transmission method includes: generating a first beacon frame, and using a first group of tones to send a first physical layer protocol data unit (PPDU) that carries the first beacon frame of a first access point (AP) being one of APs in a multi-AP (MAP) system. A transmission period of the first PPDU overlaps a transmission period of a second PPDU that carries a second beacon frame of a second AP being another of the APs in the MAP system. The first group of tones used by transmission of the first PPDU includes one or more tones that are not included in a second group of tones used by transmission of the second PPDU.

### CROSS REFERENCE TO RELATED APPLICATIONS

This application claims the benefit of U.S. Provisional Application No. 63/495,134, filed on Apr. 10, 2023. The content of the application is incorporated herein by reference.

### BACKGROUND

The present invention relates to wireless communications, and more particularly, to a method and apparatus for dealing with synchronous beacon transmission in a multi-access-point (MAP) system.

In an MAP system, there are multiple APs (e.g., AP multilink devices (MLDs)) coordinated to serve non-AP stations (STAs) (e.g., non-AP MLDs). However, each AP in an MAP system need to broadcast a beacon frame periodically, and the network efficiency may be degraded due to periodic beacon frames sent from APs. A beacon frame contains information of a basic service set (BSS), and is transmitted from an AP of the BSS periodically. Typically, a beacon frame is carried in a non-HT (Non-High Throughput) physical layer protocol data unit (PPDU) for backward compatibility, and non-HT PPDUs carrying beacon frames of different APs are transmitted in a time-division duplexing (TDD) manner. With the increasing number of APs in the MAP system, transmission of periodic beacon frames from APs occupy more air-time, which decreases the network efficiency. Thus, there is a need for an innovative beacon transmission design which is capable of reducing the air-time occupation and improving the MAP network efficiency.

### SUMMARY

One of the objectives of the claimed invention is to provide a method and apparatus for dealing with synchronous beacon transmission in a multi-access-point system.

According to a first aspect of the present invention, an exemplary beacon transmission method is disclosed. The exemplary beacon transmission method includes: generating a first beacon frame; and using a first group of tones to send a first physical layer protocol data unit (PPDU) that carries the first beacon frame of a first access point (AP) being one of APs in a multi-AP (MAP) system. A transmission period of the first PPDU overlaps a transmission period of a second PPDU that carries a second beacon frame of a second AP being another of the APs in the MAP system. The first group of tones used by transmission of the first PPDU comprises one or more tones that are not included in a second group of tones used by transmission of the second PPDU.

According to a second aspect of the present invention, an exemplary access point (AP) is disclosed. The exemplary AP includes a network interface circuit and a control circuit. The control circuit is arranged to generate a first beacon frame, and instruct the network interface circuit to use a first group of tones to send a first physical layer protocol data unit (PPDU) that carries the first beacon frame of the AP being one of APs in a multi-AP (MAP) system. A transmission period of the first PPDU overlaps a transmission period of a second PPDU that carries a second beacon frame of another AP in the MAP system. The first group of tones used by transmission of the first PPDU comprises one or more tones that are not included in a second group of tones used by transmission of the second PPDU.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an MAP system that supports a first synchronous beacon transmission scheme according to an embodiment of the present invention.

FIG. 2 is a diagram illustrating a comparison between a typical TDD-based non-synchronous beacon transmission design and a first FDD-based synchronous beacon transmission design proposed by the present invention.

FIG. 3 is a diagram illustrating another MAP system that supports a second synchronous beacon transmission scheme according to an embodiment of the present invention.

FIG. 4 is a diagram illustrating a comparison between a typical TDD-based non-synchronous beacon transmission design and a second FDD-based synchronous beacon transmission design proposed by the present invention.

FIG. 5 is a diagram illustrating a first FDD scheme employed by synchronous beacon transmission according to an embodiment of the present invention.

FIG. 6 is a diagram illustrating a second FDD scheme employed by synchronous beacon transmission according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

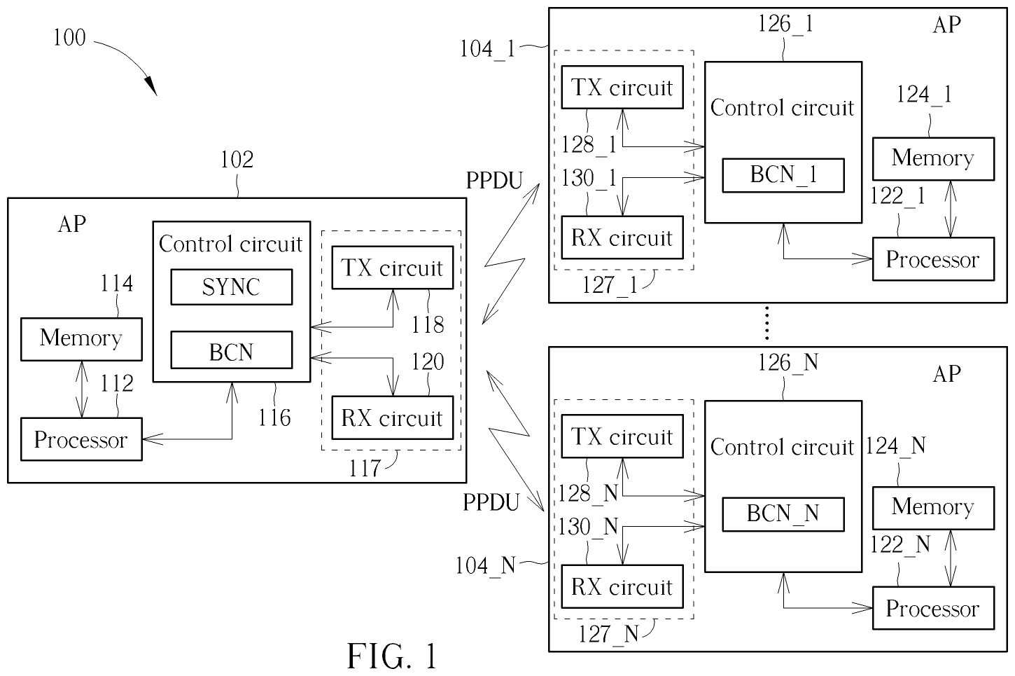

FIG. 1 is a diagram illustrating an MAP system that supports a first synchronous beacon transmission scheme according to an embodiment of the present invention. The MAP system 100 may be a Wi-Fi system compliant with IEEE 802.11bn (Wi-Fi 8) standard or a next-generation Wi-Fi standard. The MAP system 100 includes a plurality of APs 102, 104_1-104_N (N≥1). In some embodiments of the present invention, the AP 102 may act as a coordinator AP (also called master AP or primary AP) that coordinates beacon transmission in the MAP system 100.

It should be noted that an AP of the MAP system 100 may be an AP MLD which owns multiple links working on different RF bands and capable of operating at the same time, or may be a non-MLD AP. Hence, the MAP system 100 that supports the proposed synchronous beacon transmission scheme may be formed by multiple AP MLDs, multiple non-MLD APs, or a combination thereof.

The APs 102, 104_1-104_N may have the same or similar circuit structure. As shown in FIG. 1, the AP 102/104_1/104_N includes a processor 112/122_1/122_N, a memory 114/124_1/124_N, a control circuit 116/126_1/126_N, and a network interface circuit 117/127_1/127_N, where the network interface circuit 117/127_1/127_N includes a transmitter (TX) circuit 118/128_1/128_N and a receiver (RX) circuit 120/130_1/130_N. The memory 114/124_1/124_N is arranged to store a program code. The processor 112/122_1/122_N is arranged to load and execute the program code to manage the AP 102/104_1/104_N. The control circuit 116/126_1/126_N is arranged to control communications with non-AP STAs and other APs. For example, the control circuit 116/126_1/126_N controls the TX circuit 118/128_1/128_N of the network interface circuit 117/127_1/127_N to send media access control (MAC) frames (which are carried by PPDUs) to non-AP STAs and other APs, and controls the RX circuit 120/122_1/122_N of the network interface circuit 117/127_1/127_N to receive MAC frames (which are carried by PPDUs) from non-AP STAs and other APs.

It should be noted that only the components pertinent to the present invention are illustrated in FIG. 1. In practice, each of APs 102, 104_1-104_N may include additional components to achieve designated functions.

The APs 102, 104_1-104_N in the same MAP system 100 supports a first synchronous beacon transmission scheme proposed by the present invention. In accordance with the first synchronous beacon transmission scheme, the AP 102 acts as a coordinator AP that coordinates beacon transmission in the MAP system 100. Specifically, the control circuit 116 of the AP 102 is arranged to generate a synchronization frame SYNC, and instruct the network interface circuit 117 (particularly, TX circuit 118 of network interface circuit 117) to send the synchronization frame SYNC to other APs 104_1-104_N. For example, the synchronization frame SYNC may be a broadcast frame, and may act as a beacon transmission announcement frame.

The network interface circuit 127_1 (particularly, RX circuit 130_1 of network interface circuit 127_1) of the AP 104_1 receives the synchronization frame SYNC from the network interface circuit 117 (particularly, TX circuit 118 of network interface circuit 117) of the AP 102 (which acts as a coordinator AP), and the control circuit 126_1 of the AP 104_1 obtains the synchronization frame SYNC from the network interface circuit 127_1 (particularly, RX circuit 130_1 of network interface circuit 127_1). Similarly, the network interface circuit 127_N (particularly, RX circuit 130_N of network interface circuit 127_N) of the AP 104_N receives the same synchronization frame SYNC from the network interface circuit 117 (particularly, TX circuit 118 of network interface circuit 117) of the AP 102 (which acts as a coordinator AP), and the control circuit 126_N of the AP 104_N obtains the synchronization frame SYNC from the network interface circuit 127_N (particularly, RX circuit 130_N of network interface circuit 127_N).

Ideally, the synchronization frame SYNC is designed to be a short frame that does not occupy much air-time. After sending the synchronization frame SYNC, the AP 102 generates a beacon frame BCN. After receiving the synchronization frame SYNC, the AP 104_1 generates a beacon frame BCN_1. After receiving the synchronization frame SYNC, the AP 104_N generates a beacon frame BCN_N. Beacon frames BCN, BCN_1-BCN_N are sent from different APs 102, 104_1-104_N in response to the same synchronization frame SYNC. With the help of the beacon transmission coordination provided by the synchronization frame SYNC, synchronous beacon transmission among APS 102, 104_1-104_N in the same MAP system 100 is achieved. In this embodiment, the beacon frames BCN, BCN_1-BCN_N are transmitted in a frequency-division duplexing (FDD) manner to achieve interference mitigation and air-time occupation reduction.

For example, the control circuit 116 instructs the network interface circuit 117 (particularly, TX circuit 118 of network interface circuit 117) to use a first group of tones (e.g., a first resource unit (RU)) to send a first PPDU that carries the beacon frame BCN of the AP 102, the control circuit 126_1 instructs the network interface circuit 127_1 (particularly, TX circuit 128_1 of network interface circuit 127_1) to use a second group of tones (e.g., a second RU) to send a second PPDU that carries the beacon frame BCN_1 of the AP 104_1, and the control circuit 126_N (e.g., N=2) instructs the network interface circuit 127_N (particularly, TX circuit 128_N of network interface circuit 127_N) to use a third group of tones (e.g., a third RU) to send a third PPDU that carries the beacon frame BCN_N of the AP 104_N.

A transmission period of the first PPDU overlaps a transmission period of the second PPDU, and also overlaps a transmission period of the third PPDU. For example, the first PPDU, the second PPDU, and the third PPDU may have the same transmission start time due to beacon transmission coordination provided by the synchronization frame SYNC. In addition, the first group of tones (e.g., first RU) used by transmission of the first PPDU (which is a non-HT PPDU that carries the beacon frame BCN) includes one or more tones that are not included in the second group of tones (e.g., second RU) used by transmission of the second PPDU (which is a non-HT PPDU that carries the beacon frame BCN_1), and also includes one or more tones that are not included in the third group of tones (e.g., third RU) used by transmission of the third PPDU (which is a non-HT PPDU that carries the beacon frame BCN_N).

The transmission period of the second PPDU overlaps the transmission period of the first PPDU, and also overlaps the transmission period of the third PPDU. For example, the first PPDU, the second PPDU, and the third PPDU may have the same transmission start time due to beacon transmission coordination provided by the synchronization frame SYNC. In addition, the second group of tones (e.g., second RU) used by transmission of the second PPDU (which is a non-HT PPDU that carries the beacon frame BCN_1) includes one or more tones that are not included in the first group of tones (e.g., first RU) used by transmission of the first PPDU (which is a non-HT PPDU that carries the beacon frame BCN), and also includes one or more tones that are not included in the third group of tones (e.g., third RU) used by transmission of the third PPDU (which is a non-HT PPDU that carries the beacon frame BCN_N).

The transmission period of the third PPDU overlaps the transmission period of the first PPDU, and also overlaps the transmission period of the second PPDU. For example, the first PPDU, the second PPDU, and the third PPDU may have the same transmission start time due to beacon transmission coordination provided by the synchronization frame SYNC. In addition, the third group of tones (e.g., third RU) used by transmission of the third PPDU (which is a non-HT PPDU that carries the beacon frame BCN_N) includes one or more tones that are not included in the first group of tones (e.g., first RU) used by transmission of the first PPDU (which is a non-HT PPDU that carries the beacon frame BCN), and also includes one or more tones that are not included in the second group of tones (e.g., second RU) used by transmission of the second PPDU (which is a non-HT PPDU that carries the beacon frame BCN_1).

In some embodiments of the present invention, the first group of tones (e.g., first RU) used by transmission of the first PPDU (which carries the beacon frame BCN of AP 102), the second group of tones (e.g., second RU) used by transmission of the second PPDU (which carries the beacon frame BCN_1 of AP 104_1), and the third group of tones (e.g., third RU) used by transmission of the third PPDU (which carries the beacon frame BCN_N of AP 104_N) do not overlap. However, this is for illustrative purposes only, and is not meant to be a limitation of the present invention. In some embodiments of the present invention, FDD may be implemented partially so that overlapping only occurs in partial band of the transmission.

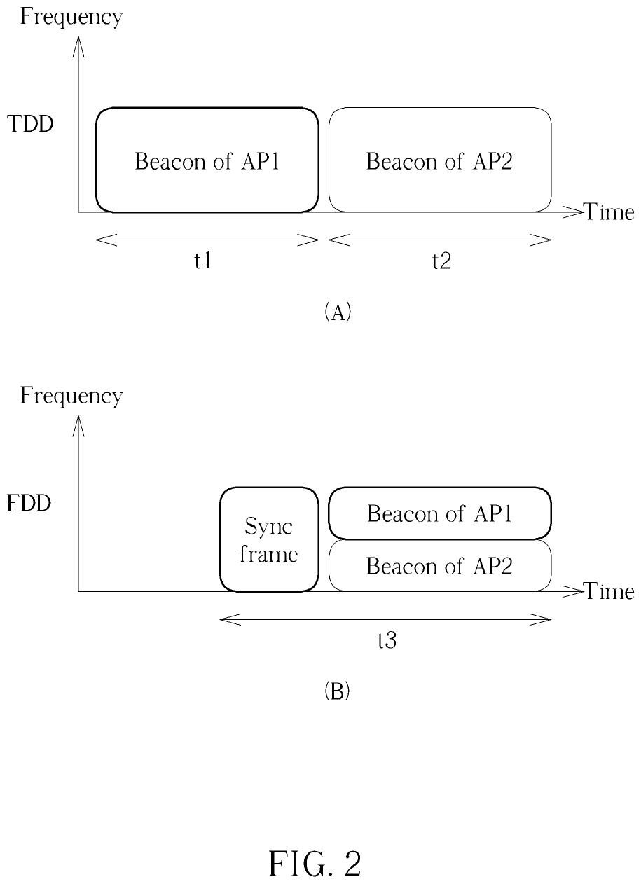

FIG. 2 is a diagram illustrating a comparison between a typical TDD-based non-synchronous beacon transmission design and a first FDD-based synchronous beacon transmission design proposed by the present invention. Suppose that an MAP system has two APs, such as AP 102 and AP 104_N (N=1) shown in FIG. 1. The sub-diagram (A) of FIG. 2 illustrates beacon frames (labeled by “Beacon of AP1” and “Beacon of AP2”) transmitted using typical TDD-based non-synchronous beacon transmission design. The sub-diagram (B) of FIG. 2 illustrates a synchronization frame (labeled by “Sync frame”) and beacon frames (labeled by “Beacon of AP1” and “Beacon of AP2”) transmitted using the proposed FDD-based synchronous beacon transmission design. Since the overall air-time occupation of FDD PPDUs of beacon frames plus the PPDU of synchronization frame is smaller than overall air-time occupation of TDD PPDUs of beacon frames (i.e., t3<t1+t2), the network efficiency can be improved.

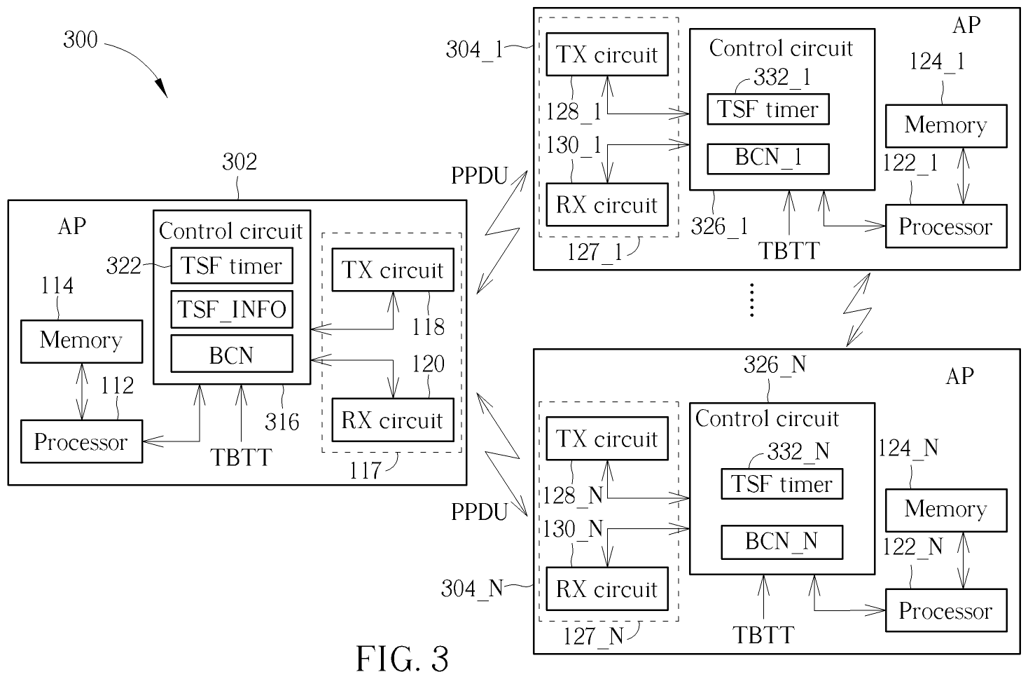

FIG. 3 is a diagram illustrating another MAP system that supports a second synchronous beacon transmission scheme according to an embodiment of the present invention. The MAP system 300 may be a Wi-Fi system compliant with IEEE 802.11bn (Wi-Fi 8) standard or a next-generation Wi-Fi standard. The MAP system 300 includes a plurality of APs 302, 304_1-304_N (N≥1). In some embodiments of the present invention, the AP 302 may act as a master AP that initiates timing synchronization function (TSF) synchronization of the MAP system 300 periodically.

It should be noted that an AP of the MAP system 300 may be an AP MLD which owns multiple links working on different RF bands and capable of operating at the same time, or may be a non-MLD AP. Hence, the MAP system 300 that supports the proposed synchronous beacon transmission scheme may be formed by multiple AP MLDs, multiple non-MLD APs, or a combination thereof.

The APs 302, 304_1-304_N may have the same or similar circuit structure. The major difference between the APs 102 and 302 is that the control circuit 316 of the AP 302 maintains a TSF timer (e.g., a 64-bit counter) 322, and generates a TSF information frame TSF_INFO for TSF synchronization of the MAP system 300. The major difference between the APs 104_1 and 304_1 is that the control circuit 326_1 maintains a TSF timer (e.g., a 64-bit counter) 332_1, and supports a TSF synchronization function. The major difference between the APs 104_N and 304_N is that the control circuit 326_N maintains a TSF timer (e.g., a 64-bit counter) 332_N, supports a TSF synchronization function.

Since the AP 302 acts as the master AP, the AP 302 is in charge of periodically initiating TSF synchronization of the MAP system 300, for ensuring accurate timing synchronization among APs 302, 304_1-304_N in the same MAP system 300. The control circuit 316 of the AP 302 is arranged to generate the TSF information frame TSF_INFO, and instruct the network interface circuit 117 (particularly, TX circuit 118 of network interface circuit 117) to send the TSF information frame TSF_INFO. The TSF information frame TSF_INFO may be directly received by a non-master AP that can listen to the master AP directly, or may be indirectly received by a non-master AP that cannot listen to the master AP directly. For example, a first non-master AP (which can listen to the master AP directly) receives the TSF information frame TSF_INFO sent from the master AP, and then sends a relayed TSF information frame to a second non-master AP (which cannot listen to the master AP directly) after TSF synchronization is performed based on the TSF information frame TSF_INFO. For another example, a first non-master AP (which can listen to the master AP directly) receives the TSF information frame TSF_INFO sent from the master AP, and then sends a relayed TSF information frame to a second non-master AP (which cannot listen to the master AP directly) after TSF synchronization is performed based on the TSF information frame TSF_INFO; and the second non-master AP (which cannot listen to the master AP directly) receives the relayed TSF information frame sent from the first non-master AP, and then sends another relayed TSF information frame to a third non-master AP (which cannot listen to the master AP directly) after TSF synchronization is performed based on the relayed TSF information frame.

The TSF information frame TSF_INFO is used to carry TSF synchronization data. For example, the TSF synchronization data may include TSF timing of the AP 302 (e.g., a value counted by the TSF timer 322 at the instant the transmission of TSF information frame TSF_INFO occurs/starts), a timing offset corresponding to a delay resulting from processing and transmission of the TSF information frame TSF_INFO, an incremental update identifier (ID) indicative of a TSF synchronization revision, or a combination thereof.

The network interface circuit 127_1 (particularly, RX circuit 130_1 of network interface circuit 127_1) of the AP 304_1 (which acts as a non-master AP) receives the TSF information frame TSF INFO sent from the master AP (or a relayed TSF information frame sent from a non-master AP), and the control circuit 326_1 of the AP 304_1 obtains the TSF information frame TSF_INFO (or relayed TSF information frame) from the network interface circuit 127_1 (particularly, RX circuit 130_1 of network interface circuit 127_1). The control circuit 326_1 of the AP 304_1 performs the TSF synchronization function according to the TSF synchronization data carried in the TSF information frame TSF_INFO (or relayed TSF information frame), to adjust the TSF timer 332_1 for synchronizing with the AP 302. In this way, both of the TSF timers 322 and 332_1 have the same value after TSF synchronization of the AP 304_1 is performed based on the TSF synchronization date carried by the TSF information frame TSF_INFO (or relayed TSF information frame).

Similarly, the network interface circuit 127_N (particularly, RX circuit 130_N of network interface circuit 127_N) of the AP 304_N (which acts as a non-master AP) receives the TSF information frame TSF_INFO sent from the master AP (or a relayed TSF information frame sent from a non-master AP), and the control circuit 326_N of the AP 304_N obtains the TSF information frame TSF_INFO (or relayed TSF information frame) from the network interface circuit 127_N (particularly, RX circuit 130_N of network interface circuit 127_N). The control circuit 326_N of the AP 304_N performs the TSF synchronization function according to the TSF synchronization data carried in the TSF information frame TSF_INFO (or relayed TSF information frame), to adjust the TSF timer 332_N for synchronizing with the AP 302. In this way, both of the TSF timers 322 and 332_N have the same value after TSF synchronization of the AP 304_N is performed based on the TSF synchronization date carried by the TSF information frame TSF_INFO (or relayed TSF information frame).

After TSF synchronization of APs 304_1-304_N are completed, all of the TSF timers 322 and 332_1-332_N at different APs 302, 304_1-304_N in the same MAP system 300 are synchronized within a predetermined timing error (e.g., 10 us). In this embodiment, the same target beacon transmission time (TBTT) setting is employed by all APs 302, 304_1-304_N in the same MAP system 300. Hence, the transmission start time of each PPDU that carries one AP's beacon frame may have a predictable timing error that is not larger than the predetermined timing error of TSF synchronization. Compared to the embodiment shown in FIG. 1, the embodiment shown in FIG. 3 does not need the synchronization frame SYNC for coordinating beacon transmission of the MAP system.

The APs 302, 304_1-304_N in the same MAP system 300 supports a second synchronous beacon transmission scheme proposed by the present invention. In accordance with the second synchronous beacon transmission scheme, APs 302, 304_1-304_N transmit their beacon frames simultaneously (i.e., at the same TBTT) in an FDD manner under periodic TSF synchronization of APs 302, 304_1-304_N.

For example, the control circuit 316 instructs the network interface circuit 117 (particularly, TX circuit 118 of network interface circuit 117) to use a first group of tones (e.g., a first RU) to send a first PPDU (which is a non-HT PPDU that carries the beacon frame BCN of the AP 302) at TBTT, the control circuit 326_1 instructs the network interface circuit 127_1 (particularly, TX circuit 128_1 of network interface circuit 127_1) to use a second group of tones (e.g., a second RU) to send a second PPDU (which is a non-HT PPDU that carries the beacon frame BCN_1 of the AP 304_1) at the same TBTT, and the control circuit 326_N (e.g., N=2) instructs the network interface circuit 127_N (particularly, TX circuit 128_N of network interface circuit 127_N) to use a third group of tones (e.g., a third RU) to send a third PPDU (which is a non-HT PPDU that carries the beacon frame BCN_N of the AP 304_N) at the same TBTT.

A transmission period of the first PPDU overlaps a transmission period of the second PPDU, and also overlaps a transmission period of the third PPDU. In addition, the first group of tones (e.g., first RU) used by transmission of the first PPDU (which carries the beacon frame BCN) includes one or more tones that are not included in the second group of tones (e.g., second RU) used by transmission of the second PPDU (which carries the beacon frame BCN_1), and also includes one or more tones that are not included in the third group of tones (e.g., third RU) used by transmission of the third PPDU (which carries the beacon frame BCN_N).

The transmission period of the second PPDU overlaps the transmission period of the first PPDU, and also overlaps the transmission period of the third PPDU. In addition, the second group of tones (e.g., second RU) used by transmission of the second PPDU (which carries the beacon frame BCN_1) includes one or more tones that are not included in the first group of tones (e.g., first RU) used by transmission of the first PPDU (which carries the beacon frame BCN), and also includes one or more tones that are not included in the third group of tones (e.g., third RU) used by transmission of the third PPDU (which carries the beacon frame BCN_N).

The transmission period of the third PPDU overlaps the transmission period of the first PPDU, and also overlaps the transmission period of the second PPDU. In addition, the third group of tones (e.g., third RU) used by transmission of the third PPDU (which carries the beacon frame BCN_N) includes one or more tones that are not included in the first group of tones (e.g., first RU) used by transmission of the first PPDU (which carries the beacon frame BCN), and also includes one or more tones that are not included in the second group of tones (e.g., second RU) used by transmission of the second PPDU (which carries the beacon frame BCN_1).

In some embodiments of the present invention, the first group of tones (e.g., first RU) used by transmission of the first PPDU (which carries the beacon frame BCN of AP 102), the second group of tones (e. g., second RU) used by transmission of the second PPDU (which carries the beacon frame BCN_1 of AP 104_1), and the third group of tones (e.g., third RU) used by transmission of the third PPDU (which carries the beacon frame BCN_N of AP 104_N) do not overlap. However, this is for illustrative purposes only, and is not meant to be a limitation of the present invention. In some embodiments of the present invention, FDD may be implemented partially so that overlapping only occurs in partial band of the transmission.

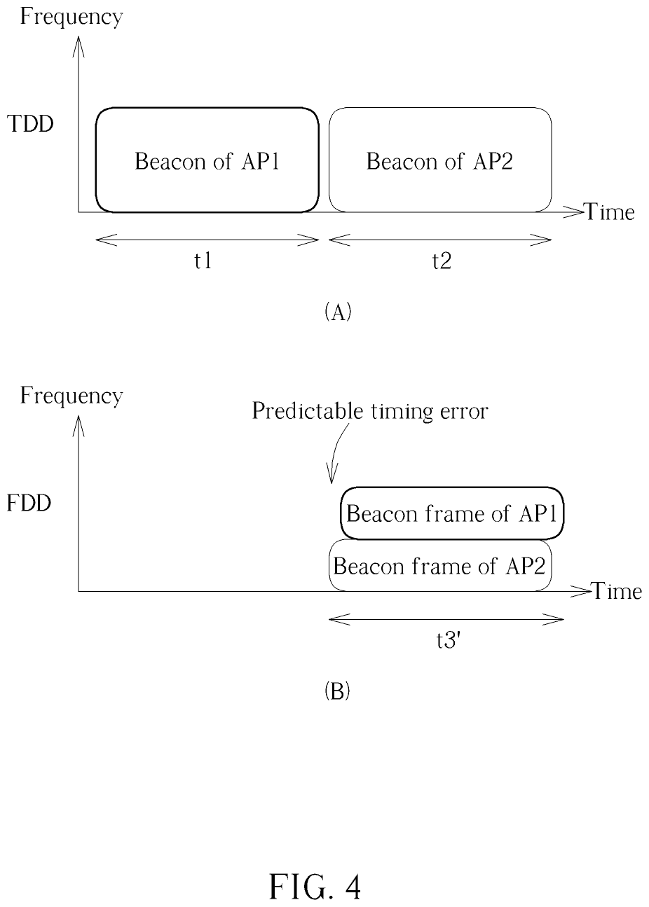

FIG. 4 is a diagram illustrating a comparison between a typical TDD-based non-synchronous beacon transmission design and a second FDD-based synchronous beacon transmission design proposed by the present invention. Suppose that an MAP system has two APs, such as AP 302 and AP 304_N (N=1) shown in FIG. 3. The sub-diagram (A) of FIG. 4 illustrates beacon frames (labeled by “Beacon of AP1” and “Beacon of AP2”) transmitted using the typical TDD-based non-synchronous beacon transmission design. The sub-diagram (B) of FIG. 4 illustrates beacon frames (labeled by “Beacon of AP1” and “Beacon of AP2”) transmitted using the proposed FDD-based synchronous beacon transmission design. Since the overall air-time occupation of FDD PPDUs of beacon frames is smaller than overall air-time occupation of TDD PPDUs of beacon frames (i.e., t3′<t1+t2), the network efficiency can be improved.

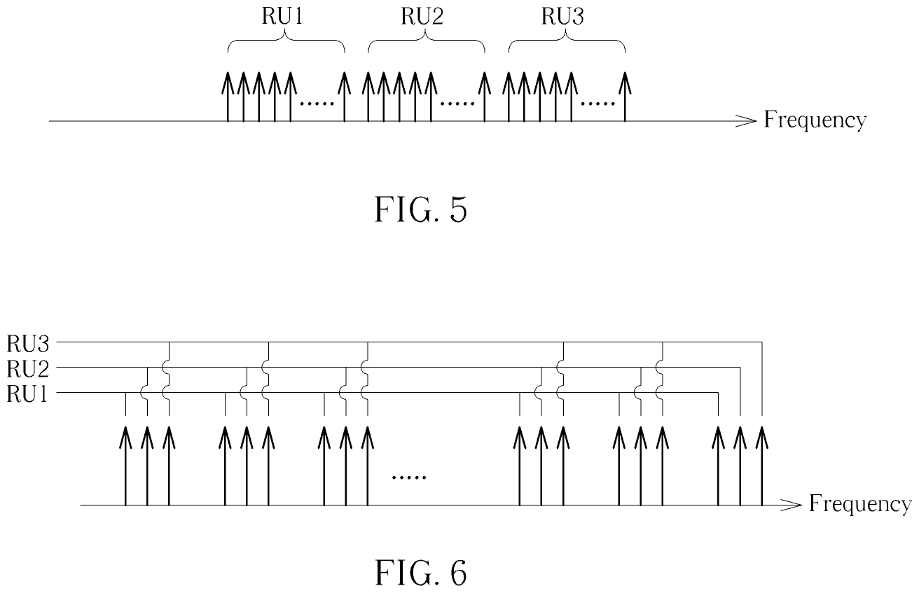

Regarding the proposed FDD-based synchronous beacon transmission design, the first group of tones (e.g., first RU) is used to send the first PPDU that carries the beacon frame BCN of the AP 102/302, the second group of tones (e.g., second RU) is used to send the second PPDU that carries the beacon frame BCN_1 of the AP 104_1/304_1, and the third group of tones (e.g., third RU) is used to send the third PPDU that carries the beacon frame BCN_N of the AP 104_N/304_N. There are two types of FDD to share the spectrum. FIG. 5 is a diagram illustrating a first FDD scheme employed by synchronous beacon transmission according to an embodiment of the present invention. Each of the first RU, the second RU, and the third RU may be a regular RU with no tones interleaved with tones of other RUS. FIG. 6 is a diagram illustrating a second FDD scheme employed by synchronous beacon transmission according to an embodiment of the present invention. Each of the first RU, the second RU, and the third RU may be a distributed RU with tones interleaved with tones of other RUs. When the distributed RU is employed, the TX power can be larger on the power spectral density (PSD) limited channels (e.g., UNII-1 and UNII-5˜UNII-8 channels).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A beacon transmission method comprising:
generating a first beacon frame; and
using a first group of tones to send a first physical layer protocol data unit (PPDU) that carries the first beacon frame of a first access point (AP) being one of APs in a multi-AP (MAP) system;
wherein a transmission period of the first PPDU overlaps a transmission period of a second PPDU that carries a second beacon frame of a second AP being another of the APs in the MAP system, and the first group of tones used by transmission of the first PPDU comprises one or more tones that are not included in a second group of tones used by transmission of the second PPDU.

2. The beacon transmission method of claim 1, wherein the first group of tones does not overlap the second group of tones.

3. The beacon transmission method of claim 1, further comprising:
generating a synchronization frame; and
sending the synchronization frame to coordinate beacon transmission of the APs in the MAP system;
wherein the first PPDU is sent in response to the synchronization frame.

4. The beacon transmission method of claim 3, wherein the first PPDU and the second PPDU have a same transmission start time.

5. The beacon transmission method of claim 1, further comprising:
receiving a synchronization frame, wherein the synchronization frame is used to coordinate beacon transmission of the APs in the MAP system;
wherein the first PPDU is sent in response to the synchronization frame.

6. The beacon transmission method of claim 5, wherein the first PPDU and the second PPDU have a same transmission start time.

7. The beacon transmission method of claim 1, wherein TFS timers of the plurality of APs in the MAP system are synchronized through periodic TFS synchronization, and a same target beacon transmission time (TBTT) setting is employed by the APs in the MAP system.

8. The beacon transmission method of claim 1, wherein the first group of tones is a regular resource unit (RU) with no tones interleaved with tones of other RUs.

9. The beacon transmission method of claim 1, wherein the first group of tones is a distributed resource unit (RU) with tones interleaved with tones of other RUs.

10. An access point (AP) comprising:
a network interface circuit; and
a control circuit, arranged to generate a first beacon frame, and instruct the network interface circuit to use a first group of tones to send a first physical layer protocol data unit (PPDU) that carries the first beacon frame of the AP being one of APs in a multi-AP (MAP) system;
wherein a transmission period of the first PPDU overlaps a transmission period of a second PPDU that carries a second beacon frame of another AP included in the APs in the MAP system, and the first group of tones used by transmission of the first PPDU comprises one or more tones that are not included in a second group of tones used by transmission of the second PPDU.

11. The AP of claim 10, wherein the first group of tones does not overlap the second group of tones.

12. The AP of claim 10, wherein the control circuit is further arranged to generate a synchronization frame, and instruct the network interface circuit to send the synchronization frame to coordinate beacon transmission of the APs in the MAP system; and
the first PPDU is sent in response to the synchronization frame.

13. The AP of claim 12, wherein the first PPDU and the second PPDU have a same transmission start time.

14. The AP of claim 10, wherein the control circuit is further arranged to receive a synchronization frame through the network interface circuit, where the synchronization frame is used to coordinate beacon transmission of the APs in the MAP system; and
the first PPDU is sent in response to the synchronization frame.

15. The AP of claim 14, wherein the first PPDU and the second PPDU have a same transmission start time.

16. The AP of claim 10, wherein TFS timers of the plurality of APs in the MAP system are synchronized through periodic TFS synchronization, and a same target beacon transmission time (TBTT) setting is employed by the APs in the MAP system.

17. The AP of claim 10, wherein the first group of tones is a regular resource unit (RU) with no tones interleaved with tones of other RUs.

18. The AP of claim 10, wherein the first group of tones is a distributed resource unit (RU) with tones interleaved with tones of other RUs.
